(19) United States
(12) Patent Application Publication
(10) Pub. No.: US 2022/0317837 A1
(43) Pub. Date: Oct. 6, 2022

(54) VEHICLE DISPLAY SYSTEM, DISPLAY METHOD, AND RECORDING MEDIUM

(71) Applicant: Panasonic Intellectual Property Management Co., Ltd., Osaka (JP)

(72) Inventors: Atsuya NASU, Osaka (JP); Daisuke MISONOO, Kanagawa (JP)

(73) Assignee: Panasonic Intellectual Property Management Co., Ltd., Osaka (JP)

(21) Appl. No.: 17/703,240

(22) Filed: Mar. 24, 2022

(30) Foreign Application Priority Data
Mar. 31, 2021 (JP) 2021-060131

(51) Int. Cl. G06F 3/0484; G06F 3/147; G06F 9/451; B60K 35/00

(52) U.S. Cl. CPC G06F 3/0484; G06F 3/147; G06F 9/451; B60K 35/00; H04L 67/125

(57) ABSTRACT

A vehicle display system includes: a control device that causes at least one of a plurality of display devices to display a customization image on which a display screen can be customized and that transmits, to each of the display devices, display content generated based on a display layout customized by a user on the customization image, and each of the display devices displays the display content received from the control device.

### CROSS REFERENCE TO RELATED APPLICATION

The present application is based on and claims priority of Japanese Patent Application No. 2021-060131 filed on Mar. 31, 2021.

### FIELD

The present disclosure relates to vehicle display systems, display methods, and recording media.

### BACKGROUND

In recent years, as a vehicle display system has advanced, the number of display devices in a vehicle interior space has tended to be increased, and thus the change of a vehicle interior into a living space is accelerated. Hence, in order to form an optimal vehicle interior space for a user, it is required to customize screen displays in a plurality of display devices.

PTL 1 discloses a vehicle information providing device that includes: a visual information providing means which displays a customizing mode setting screen, when a customizing mode for vehicle state information is executed; and a control means which executes processing for displaying an overall layout of the vehicle state information as a preview display on the customizing mode setting screen.

### CITATION LIST

### Patent Literature

PTL 1: Japanese Patent No. 6176472

### SUMMARY

The vehicle information providing device of PTL 1 described above can be improved upon.

In view of this, the vehicle display system, the display method, and the recording medium of the present disclosure are capable of improving upon the above related art.

A vehicle display system according to an aspect of the present disclosure includes: a control device that causes at least one of a plurality of display devices to display a customization image on which a display screen can be customized and that transmits, to each of the plurality of display devices, display content generated based on a display layout customized by a user on the customization image, and each of the plurality of display devices displays the display content received from the control device.

These comprehensive or specific aspects may be realized by a system, a method, an integrated circuit, a computer program, or a computer-readable recording medium such as a CD-ROM or may be realized by any combination of a system, a method, an integrated circuit, a computer program, and a recording medium.

According to the present disclosure, it is possible to achieve further improvement.

### BRIEF DESCRIPTION OF DRAWINGS

These and other advantages and features of the present disclosure will become apparent from the following description thereof taken in conjunction with the accompanying drawings that illustrate a specific embodiment of the present disclosure.

FIG. 1A is a block diagram illustrating a control device in a vehicle display system according to Embodiment 1.

FIG. 1B is a block diagram illustrating a display device in the vehicle display system according to Embodiment 1.

FIG. 2 is a sequence diagram illustrating a processing operation executed by a display customizer in the vehicle display system according to Embodiment 1.

FIG. 3 is a diagram illustrating how a customizing mode is executed and a customizing operation is performed in the vehicle display system.

FIG. 4 is a block diagram illustrating a control device in a vehicle display system according to Embodiment 2.

FIG. 5 is a diagram illustrating a table in which the degree of risk corresponding to the state of travel of a vehicle and whether an obstruction is present around the vehicle is classified.

FIG. 6 is a sequence diagram illustrating a processing operation when a shift position is located in a park position.

FIG. 7 is a diagram illustrating how a display layout during parking and a display layout during travel are switched.

FIG. 8 is a sequence diagram illustrating a processing operation when the shift position is located in a position other than the park position.

### DESCRIPTION OF EMBODIMENTS

In the vehicle information providing device of PTL 1 which is a related art, a display is produced on a screen in each control means, and thus an application installed in the control means is only customized. Therefore, in the vehicle information providing device, in order to realize such customization that an application across a plurality of vehicle-mounted displays is displayed and that a display on another display other than the vehicle-mounted displays is copied, it is necessary to install the same application in each control means, and it is also necessary to customize a display layout for each control means.

Hence, the present disclosure provides a vehicle display system, a display method, and a recording medium in which it is possible to collectively install a plurality of applications in one control device and collectively customize a display layout for a plurality of display devices.

Embodiments of the present disclosure will be described below with reference to drawings. The embodiments described below show specific preferred examples of the present disclosure. Thus, values, shapes, materials, constituent elements, the arrangements, positions, and connection forms of the constituent elements, and the like which are shown in the embodiments below are examples, and are not intended to limit the present disclosure. Therefore, among the constituent elements in the embodiments below, constituent elements which are not recited in the independent claims are described as arbitrary constituent elements.

The drawings each are schematic views, and are not exactly shown. Hence, in the drawings, the same constituent members are identified with the same reference signs.

The embodiments will be specifically described below with reference to the drawings.

### Embodiment 1

### <Configuration: Vehicle Display System 1>

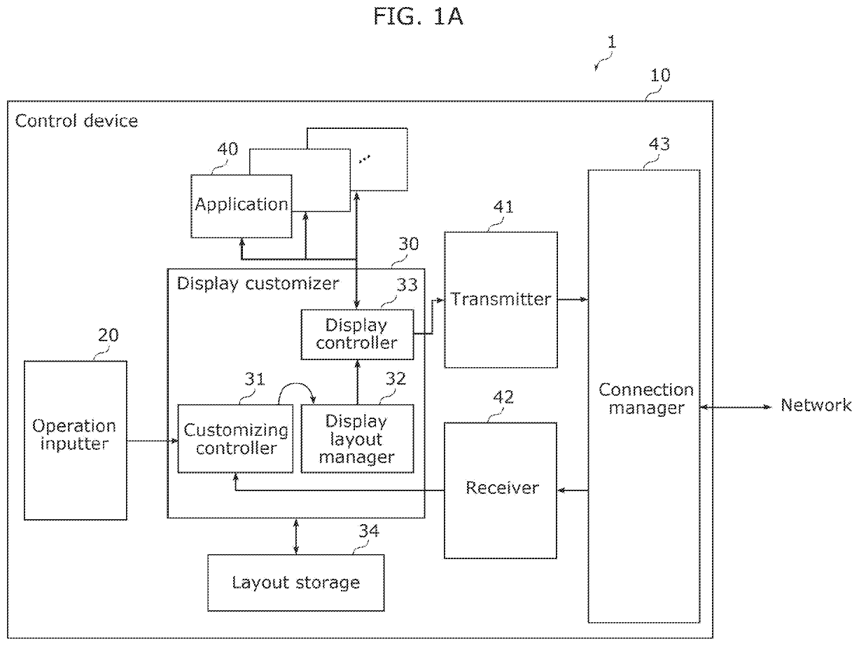

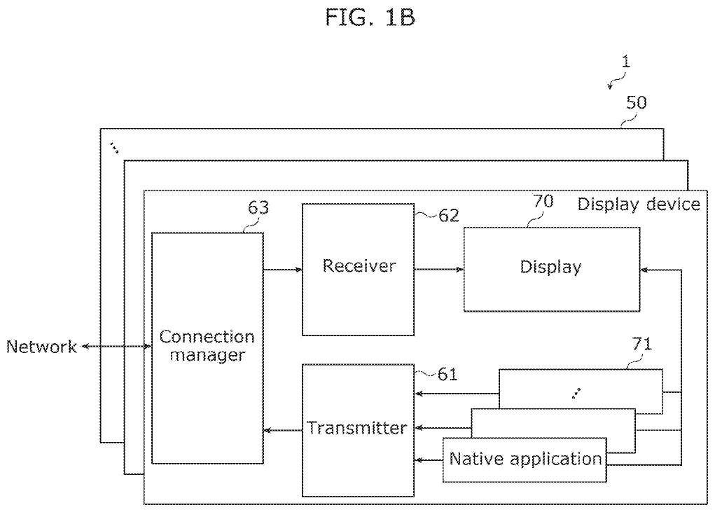

FIG. 1A is a block diagram illustrating control device 10 in vehicle display system 1 according to Embodiment 1. FIG. 1B is a block diagram illustrating display device 50 in vehicle display system 1 according to Embodiment 1.

As shown in FIGS. 1A and 1B, vehicle display system 1 is installed in a vehicle and executes a customizing mode for registering various types of setting content on the vision of a user to generate display content which is an image customized according to the preference of the user and to display the generated image on the display screens of a plurality of display devices 50. Specifically, when the user causes vehicle display system 1 to execute the customizing mode, since a customization image is displayed on part of display devices 50, part images for executing applications 40 on the customization image, arrangements, positions, sizes, and display formats thereof, and the like can be customized according to the preference. The display content customized by the user can be displayed on the display screens of display devices 50 provided in the vehicle.

Here, the customization image is an image which can be customized according to the preference of the user. For example, on the customization image, one or more part images are selected from a plurality of part images, and the arrangements, positions, sizes, and display formats of the selected part images can be determined. The part images are the content of applications 40 for displaying, as the state of the vehicle, for example, vehicle instruments, the operating statuses of vehicle-mounted devices, navigation information, the degree of risk on the travel of the vehicle, and the like. The vehicle instruments are, for example, a speed meter, a turn-signal light, a warning light, an odometer, a shift position, a fuel gauge, a water temperature gauge, and the like. The vehicle-mounted devices are, for example, an audio device, a vehicle-mounted lighting device, display device 50, a seat device and the like.

Vehicle display system 1 includes control device 10 and a plurality of display devices 50.

Control device 10 includes operation inputter 20, layout storage 34, display customizer 30, applications 40, transmitter 41, receiver 42, and connection manager 43.

Operation inputter 20 is an input interface which receives an operation input produced by the user. Specifically, when a touch panel display is installed, the touch panel display functions as display 70 and operation inputter 20. Operation inputter 20 is not limited to the touch panel display, and may be, for example, a keyboard, a pointing device, mechanical switches, or the like.

Operation inputter 20 receives, for example, an operation input produced by the user to be able to output, to display customizer 30, an instruction to read layout information stored in layout storage 34. Operation inputter 20 receives, for example, an operation input produced by the user to be able to output, to display customizer 30, an instruction to execute the customizing mode. When the customizing mode is executed, operation inputter 20 receives, for example, an operation input produced by the user to be able to output, to display customizer 30, an instruction to customize a display layout on the customization image. Operation inputter 20 can normally output, to the vehicle-mounted devices, an ECU, and the like, instructions to control the operations of the vehicle-mounted devices and the like.

In layout storage 34, customized layout information, previously stored layout information, the part images, texture images, and the like are stored. The layout information is information indicating the display layout of one or more part images. The display layout indicates the arrangement, the position, the size, the display format, and the like which are determined for each of the part images.

Layout storage 34 includes, for example, electrically rewritable nonvolatile semiconductor memories such as a flash memory. Hence, layout storage 34 includes, for example, primary storage devices such as a random access memory (RAM) and a read only memory (ROM). Layout storage 34 may include secondary storage devices such as a flash memory, a hard disk drive (HDD) and a solid state drive (SSD) and tertiary storage devices such as an SD card.

Display customizer 30 reads the layout information stored in layout storage 34, and outputs the read layout information via transmitter 41 and the like to each of display devices 50. Display customizer 30 can output the layout information via applications 40 and the like to one or more of display devices 50. Display customizer 30 may be an example of the control device.

Specifically, display customizer 30 includes customizing controller 31, display layout manager 32, and display controller 33.

Customizing controller 31 executes the customizing mode when customizing controller 31 acquires the instruction from operation inputter 20. Customizing controller 31 acquires display screen information from each of display devices 50 when the customizing mode is executed. The display screen information is information on the texture image set for each of display devices 50. Customizing controller 31 causes display devices 50 to display the texture images of display devices 50 on the customization image when the customizing mode is executed.

Customizing controller 31 acquires, from operation inputter 20, the instruction to customize the display layout on the customization image, and thereby forms the display layout which includes one or more part images, the arrangements, positions, sizes and display formats thereof, and the like. Customizing controller 31 outputs the formed display layout to display layout manager 32 when customizing controller 31 forms the display layout.

Display layout manager 32 manages the display layout acquired from customizing controller 31. Specifically, display layout manager 32 stores the acquired display layout in layout storage 34 to update or store the layout information.

After display layout manager 32 changes the layout information and updates or stores the layout information, display layout manager 32 outputs, to display controller 33, the acquired display layout in order to apply the display layout indicated by the layout information updated or stored to each of display devices 50.

Display controller 33 controls, based on the acquired display layout, the display of the part images of applications 40 when display controller 33 acquires, from display layout manager 32, the display layout indicated by the layout information. In other words, display controller 33 generates the display content based on the display layout. The display content includes the part images displayed in each of display devices 50, the arrangements, positions, sizes, and display formats thereof, the texture images, and the like, which are described above.

Display controller 33 transmits the generated display content to each of display devices 50 via transmitter 41, connection manager 43, a network, and the like.

Display customizer 30 manages all applications 40 for customizing the customization image to display the customization image on each of display devices 50 in accordance with a customization restriction corresponding to the status of driving of the vehicle installing vehicle display system 1. In other words, in terms of functional safety on the travel of the vehicle, it is necessary to display essential information of, for example, part images on vehicle instruments for a vehicle speed display and the like such that the essential information is recognized by a driver included in users. Hence, display customizer 30 manages the arrangements, positions, sizes, and display formats of the essential information so as to achieve the display formats with consideration given to the functional safety. Therefore, for example, for the display device which is arranged in front of a driver seat, a given customization restriction may be imposed. For information which is not essential, in terms of the functional safety, such as part images and the like on the operating statuses of vehicle-mounted devices for turning on and off of an air conditioner, the sound level of the audio device, and the like, a restriction is imposed on the arrangements thereof so as not to hide the essential information.

Applications 40 are operated on the OS of the ECU serving as hardware in control device 10. Applications 40 are associated with, for example, the part images on vehicle instruments for the vehicle speed display where a vehicle speed is displayed, the number of revolutions of an engine, and the like, the part images on the operating statuses of the vehicle-mounted devices for turning on and off of the air conditioner, the sound level of the audio device, and the like, part images on the navigation information of a route map and the like, part images indicating the degree of risk on the travel of the vehicle, and the like.

Transmitter 41 is connected via connection manager 43 to the network to be able to communicate therewith. Transmitter 41 transmits the display content generated by display controller 33 via connection manager 43 and the network to display devices 50.

Receiver 42 is connected via connection manager 43 to the network to be able to communicate therewith. Receiver 42 receives the display screen information via the network and connection manager 43 from each of display devices 50.

Connection manager 43 checks whether control device 10 can be connected to the network to communicate therewith and checks whether control device 10 can be connected via the network to each of display devices 50 to communicate therewith, and thereby manages the statues of the network and each of display devices 50.

Display devices 50 are displays such as a car navigation system installed in a vehicle, an electronic mirror system, a multi-information display, and a head-up display (HUD). In the present embodiment, as display devices 50, a car navigation system which is arranged in a center part of the width of the vehicle, an electronic mirror system which functions as a left side mirror and a right side mirror, a plurality of multi-information displays are illustrated. Display devices 50 described above are arranged side by side such that a passenger in the vehicle can collectively see a plurality of display devices 50. In the present embodiment, display devices 50 are aligned along the direction of the width of the vehicle.

Each of display devices 50 displays the display content in which the display layout of the arrangements, positions, sizes, display formats, and the like of, for example, the part images on vehicle instruments for the vehicle speed display where the vehicle speed is displayed, the number of revolutions of the engine, and the like, the part images on the operating statuses of the vehicle-mounted devices for turning on and off of the air conditioner, the sound level of the audio device, and the like, the part images on the navigation information of the route map and the like, the part images indicating the degree of risk on the travel of the vehicle, and the like are determined. In other words, each of display devices 50 displays applications 40 associated with the part images.

Two or more of display devices 50 are coordinated by vehicle display system 1, and thus they can display a single image or each of them can individually display an image. Two or more of display devices 50 are coordinated and controlled by a plurality of control devices 10, and thus the texture images of display devices 50 can be unified.

Each of display devices 50 includes connection manager 63, receiver 62, transmitter 61, display 70, and native applications 71.

Connection manager 63 checks whether display device 50 can be connected to the network to communicate therewith and checks whether display device 50 can be connected via the network to control device 10 to communicate therewith, and thereby manages the statuses of the network and control device 10.

Receiver 62 is connected via connection manager 63 to the network to be able to communicate therewith. Receiver 62 receives the display content via the network and connection manager 63 from control device 10.

Transmitter 61 is connected via connection manager 63 to the network to be able to communicate therewith. Transmitter 61 transmits the display screen information including the texture images extracted from native applications 71 via connection manager 63 and the network to control device 10.

Display 70 is a monitor which displays the display content output by control device 10. Display 70 is, for example, a liquid crystal panel, an organic electro luminescence (EL) panel, or the like. Display 70 can integrate the display content with the texture images extracted by native applications 71 to produce a display.

Native applications 71 extract the texture image in the image displayed on display 70, output the display screen information including the extracted texture image via transmitter 61 and connection manager 63 to the network, and output the display screen information to display 70.

### <Processing Operation>

A processing operation in vehicle display system 1, a display method, and a recording medium according to the present embodiment will then be described.

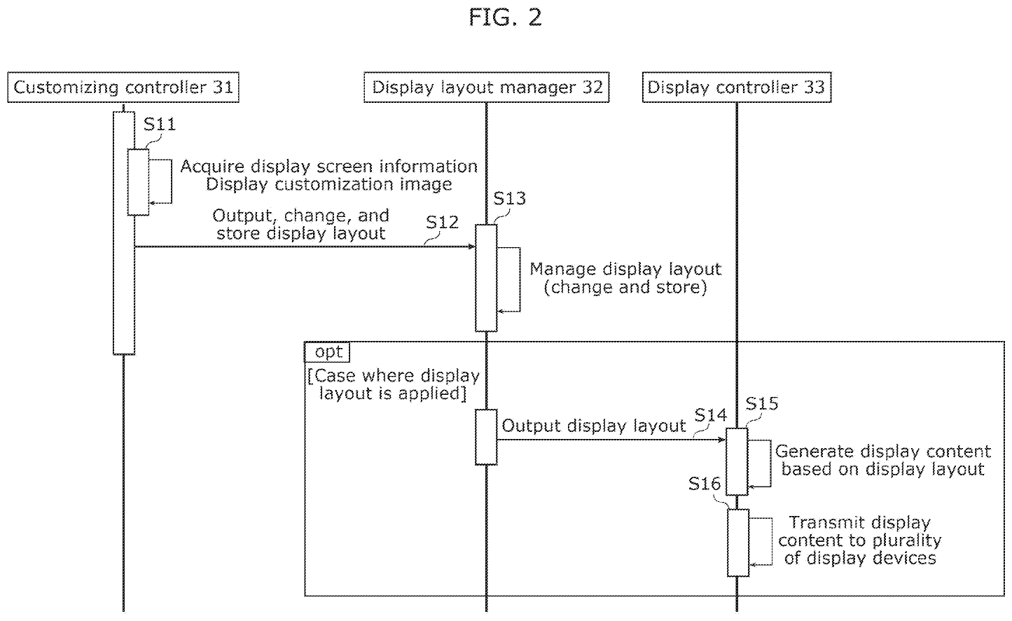

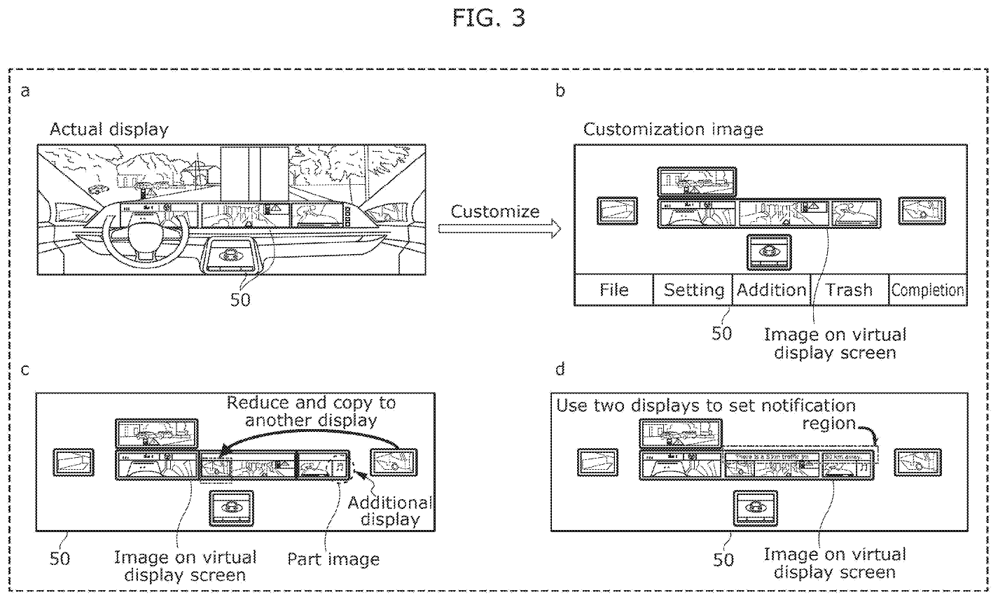

FIG. 2 is a sequence diagram illustrating a processing operation executed by display customizer 30 in vehicle display system 1 according to Embodiment 1. FIG. 3 is a diagram illustrating how the customizing mode is executed and a customizing operation is performed in vehicle display system 1. Images on virtual display screens displayed on the customization images shown in b to d in FIG. 3 correspond to the positions of the display screens of each of display devices 50 arranged actually in the vehicle.

First, as shown in FIG. 2 and a and b in FIG. 3, an operation input is produced by the user on operation inputter 20, and thus customizing controller 31 of display customizer 30 acquires the instruction to execute the customizing mode and causes display device 50 to display the customization image. Customizing controller 31 acquires the display screen information from each of display devices 50. In this way, customizing controller 31 applies the texture image of display device 50 onto the customization image, transmits the customization image and the texture image after the application via transmitter 41, connection manager 43, and the network to display device 50, and thereby causes display device 50 to display an image in which the customization image and the texture image are combined together (S11). Customizing controller 31 may cause only one or more of display devices 50 to display the customization images.

In this way, the user customizes, while seeing the customization images displayed on display devices 50, the customization images to desired forms. For example, as shown in c in FIG. 3, on the customization image displayed on display device 50, an image on the virtual display screen is selected and swiped, and thus, for example, the image (an example of the part image) on the virtual display screen can be copied, added, or moved to another image on the virtual display screen or a part image can be added. For example, as indicated by chain double-dashed lines in d in FIG. 3, images on the virtual display screens are selected, and thus a display region can be set to be over a plurality of virtual display screens. As described above, the user can freely and simply customize part images to determine the arrangements, positions and sizes thereof. An image displayed on a display screen in another display device can be moved to a display screen in a desired display device.

By the customization as shown in c and d in FIG. 3, customizing controller 31 forms, on the customization image, a display layout which includes one or more part images, the arrangements, positions, sizes, and display formats thereof, and the like.

When customizing controller 31 forms the display layout, customizing controller 31 outputs the formed display layout to display layout manager 32 to update or store the formed display layout (S12).

Display layout manager 32 acquires the display layout from customizing controller 31, and manages the acquired display layout (S13). Specifically, display layout manager 32 stores the acquired layout information in layout storage 34 to update or store the layout information.

Here, display layout manager 32 outputs the acquired display layout to display controller 33 to apply the display layout indicated by the layout information updated or stored to each of display devices 50 (S14).

When display controller 33 acquires the display layout indicated by the layout information from display layout manager 32, display controller 33 adjusts, based on the display layout, the display of part images in applications 40 to generate the display content corresponding to the display layout (S15).

Then, display controller 33 transmits the generated display content via transmitter 41, connection manager 43, and the network to each of display devices 50 (S16). Since an identification number is associated with display content so as to be applied to each of display devices 50, individual display content is transmitted to each of display devices 50.

In this way, each of display devices 50 acquires the display content to be able to display the display content customized by the user.

When after step S13, the display layout updated or stored is not applied to each of display devices 50, the processing operation in FIG. 3 is completed.

### <Functional Effects>

The functional effects of vehicle display system 1 according to the present embodiment will then be described.

As described above, vehicle display system 1 according to the present embodiment includes control device 10 that causes at least one of a plurality of display devices 50 to display a customization image on which a display screen can be customized and that transmits, to each of display devices 50, display content generated based on a display layout customized by a user on the customization image. Each of display devices 50 displays the display content received from control device 10.

For example, when control devices are respectively provided for a plurality of display devices, since it is necessary to generate display content for each of the control devices, an adjustment operation for generating the display content is needed, with the result that there is a concern about an increase in the number of steps to be performed and the resulting increase in the energy cost of vehicle display system 1.

However, in the present disclosure, a display layout for a plurality of display devices 50 can be collectively customized. Control device 10 transmits the display content of the customized display layout to each of display devices 50 to be able to collectively display the display content corresponding to each of display devices 50.

Hence, in vehicle display system 1, a plurality of applications 40 can be collectively installed in one control device 10, and a display layout for a plurality of display devices 50 can be collectively customized. Consequently, in vehicle display system 1, it is possible to suppress an increase in the number of steps to be performed and an increase in the energy cost of vehicle display system 1.

In particular, in vehicle display system 1 of the present embodiment, a display layout for a plurality of display devices 50 can be collectively customized in one control device 10, and thus it is not necessary to install control device 10 and applications 40 in a plurality of display devices 50. Hence, it is possible to suppress an increase in the manufacturing cost of vehicle display system 1.

In the display method according to the present embodiment, a customization image is displayed on a display screen, display content generated based on a display layout customized on the customization image by the user is transmitted to each of a plurality of display devices 50, and each of display devices 50 displays the display content received from control device 10.

In the display method described above, the same functional effects as described above are achieved.

The recording medium according to the present embodiment is a non-transitory computer-readable recording medium in which a program for instructing a computer to execute the display method is recorded.

In the recording medium described above, the same functional effects as described above are achieved.

In vehicle display system 1 according to the present embodiment, control device 10 manages applications 40 for customizing the customization image and displays the customization image on each of display devices 50 in accordance with a customization restriction corresponding to the status of driving of a vehicle installing vehicle display system 1.

In this way, essential information for driving can be restricted to be a display layout capable of being recognized by a driver, and thus it is possible to ensure safety on the travel of the vehicle.

In vehicle display system 1 according to the present embodiment, control device 10 acquires display screen information that is information on display devices 50 and causes, when a customizing operation is performed with respect to the display layout, display devices 50 to respectively display, based on the display screen information, texture images imitating display devices 50.

In this way, when the customizing operation is performed with respect to the display layout, a display is produced by imitating the image on the display screen of display device 50, and thus the customization image close to the actual image displayed on the display screen of display device 50 can be displayed. Hence, the user can perform the customizing operation while imaging a desired display layout to be realized. The visibility of the user when the customizing operation is performed is enhanced.

Vehicle display system 1 according to the present embodiment includes a plurality of display devices 50 that display the customization image on which a display screen can be customized.

In this way, control device 10 can display the display layout customized on the customization image.

### Embodiment 2

The vehicle display system of the present embodiment differs from the vehicle display system of Embodiment 1, for example, in that shift position detector 21, degree-of-risk calculator 22, and driving status classifier 35 are provided. Unless otherwise specified, other configurations in the present embodiment are the same as in Embodiment 1, the same configurations are identified with the same reference signs, and detailed description of the configurations will be omitted.

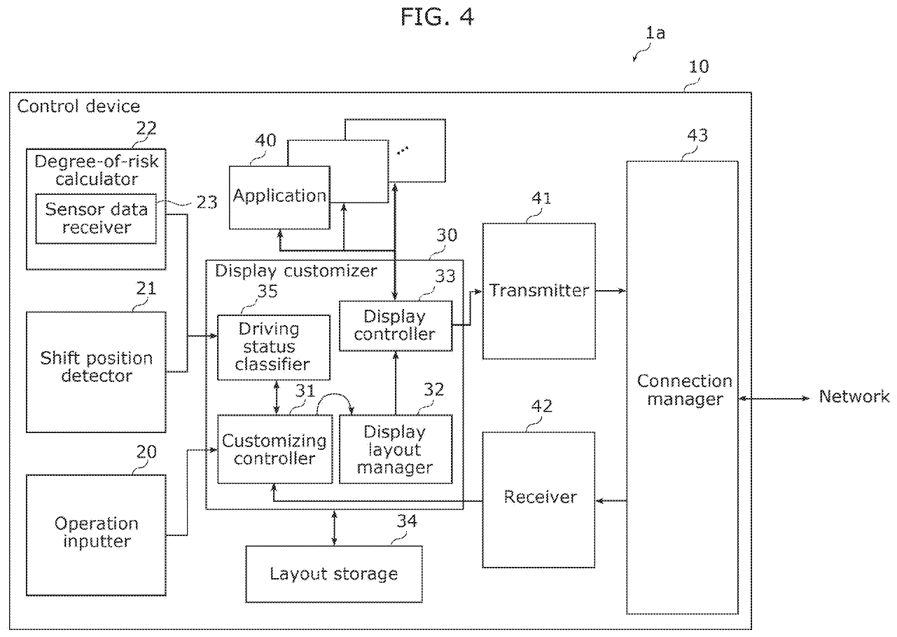

FIG. 4 is a block diagram illustrating control device 10 in vehicle display system 1a according to Embodiment 2.

As shown in FIG. 4, control device 10 in vehicle display system 1a includes operation inputter 20, layout storage 34, display customizer 30, applications 40, transmitter 41, receiver 42, and connection manager 43, and further includes degree-of-risk calculator 22 and shift position detector 21. Display customizer 30 includes customizing controller 31, display layout manager 32, and display controller 33, and further includes driving status classifier 35.

Degree-of-risk calculator 22 calculates the degree of risk on the travel of the vehicle. Specifically, sensor data receiver 23 of degree-of-risk calculator 22 receives, for example, vehicle speed information from a vehicle speed sensor, distance information from a distance sensor, and the like. The vehicle speed information is information which indicates a vehicle speed. The distance information is information which indicates a distance from the vehicle to an obstruction. Here, the degree of risk indicates the risk of the vehicle during driving. For example, the degree of risk is calculated by degree-of-risk calculator 22 based on the vehicle speed, whether an obstruction is present around the vehicle, a distance from the vehicle to the obstruction, and the like. The phrase “during driving” includes, for example, a time during which the vehicle travels and a time during which the vehicle is parked when an ignition switch is on. A threshold value is a value which is previously set.

Degree-of-risk calculator 22 outputs, to driving status classifier 35 of display customizer 30, the degree of risk in the vehicle which is calculated.

Shift position detector 21 detects a shift position in the vehicle. Hence, shift position detector 21 detects a change in the shift position in the vehicle. Shift position detector 21 outputs, to driving status classifier 35 and sensor data receiver 23 of degree-of-risk calculator 22, position information which is information indicating the detected shift position.

When driving status classifier 35 acquires the degree of risk in the vehicle and the position information from degree-of-risk calculator 22, driving status classifier 35 classifies the status of driving in the vehicle based on the degree of risk and the shift position indicated by the position information.

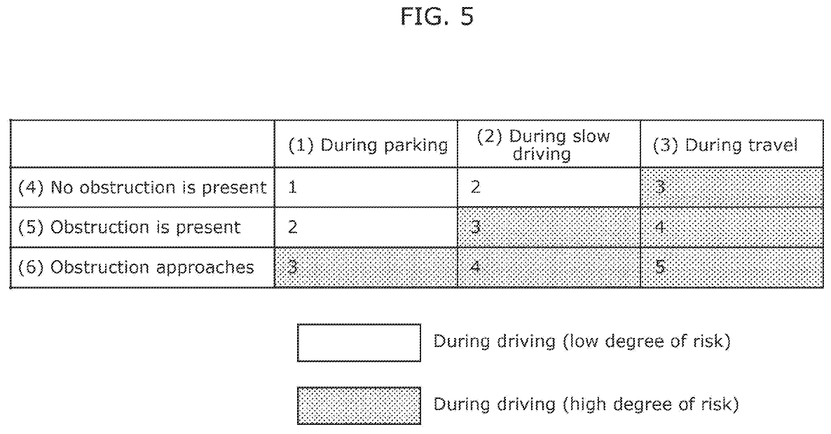

For example, a table in FIG. 5 is used, and thus the status of driving can be classified as to whether the degree of risk of the vehicle in the status of driving is high or low. FIG. 5 is a diagram illustrating the table in which the state of travel of the vehicle and the degree of risk corresponding to whether an obstruction is present around the vehicle are classified.

In the classification of the status of driving, for example, the status of driving is classified as to whether the degree of risk of the vehicle is high or low from a relationship between the states of (1) during which the vehicle is parked when the ignition switch is on, (2) during which the vehicle is driven slowly, and (3) during which the vehicle travels and the cases of (4) a case where no obstruction is present near the vehicle, (5) a case where an obstruction is present near the vehicle, and (6) a case where an obstruction approaches the vehicle. FIG. 5 shows that as the value is increased, the degree of risk is increased. For example, in the combination of (1) and (4), the vehicle is parked and no obstruction is present near the vehicle, and thus it is considered that the degree of risk is low. Hence, the degree of risk is set to “1” which is the lowest.

In the combination of (1) and (5), an obstruction is present near the vehicle but the vehicle is parked, and thus it is considered that the degree of risk is low. In the combination of (2) and (4), the vehicle is driven slowly and no obstruction is present near the vehicle, and thus it is considered that the degree of risk is low. Hence, the degree of risk is set to “2”.

In the combination of (1) and (6), the vehicle is parked but an obstruction approaches the vehicle, and thus it is considered that the degree of risk is somewhat high. In the combination of (2) and (5), the vehicle is driven slowly but an obstruction is present near the vehicle, and thus it is considered that the degree of risk is somewhat high. In the combination of (3) and (4), no obstruction is present near the vehicle but the vehicle travels, and thus it is considered that the degree of risk is somewhat high. Hence, the degree of risk is set to “3”.

In the combination of (2) and (6), the vehicle is driven slowly but an obstruction approaches the vehicle, and thus it is considered that the degree of risk is high. In the combination of (3) and (5), the vehicle travels and an obstruction is present near the vehicle, and thus it is considered that the degree of risk is high. Hence, the degree of risk is set to “4”.

In the combination of (3) and (6), the vehicle travels and an obstruction approaches the vehicle, and thus it is considered that the degree of risk is very high. Hence, the degree of risk is set to “5” which is the highest.

The classification in FIG. 5 described above is only an example, and a configuration may be adopted in which the classification can be arbitrarily changed and set. For example, automated driving may be included as the status of driving.

As shown in FIG. 4, display customizer 30 restricts the customizing operation to be performed with respect to the display layout based on the shift position in the vehicle and the degree of risk during travel. This restriction focuses on a case where the classification for the status of driving is shown in FIG. 5. Hence, the method of restricting the customizing operation and the block configuration of FIG. 4 may differ according to the method of classifying the status of driving. For example, whether the vehicle is automatically driven is determined, and when the vehicle is automatically driven, the customizing operation is allowed to be performed in detail in accordance with a customization restriction.

Specifically, driving status classifier 35 determines whether the shift position in the vehicle indicated by the position information is in a position other than the park position.

When the shift position indicated by the position information is located in the park position, driving status classifier 35 determines that the degree of risk is zero. In other words, since the vehicle cannot travel (during parking), it is considered that the degree of risk is zero. When the shift position in the vehicle is located in the park position, customizing controller 31 allows the customizing operation to be performed in detail in accordance with the customization restriction.

When the shift position is in a position other than the park position, driving status classifier 35 determines that the degree of risk is not zero. In other words, since the vehicle can travel or the vehicle travels, it is considered that the degree of risk is not zero. Driving status classifier 35 classifies whether the degree of risk of the vehicle described above is high or low, and outputs the result of the classification to customizing controller 31. Customizing controller 31 restricts the customizing operation to be performed with respect to the display layout based on the result of the classification. Specifically, when the degree of risk is less than or equal to the threshold value, customizing controller 31 allows only a switch to a stored display layout for driving whereas when the degree of risk calculated is greater than the threshold value, the customizing operation to be performed with respect to the display layout is prohibited.

Driving status classifier 35 acquires the position information obtained by detecting a change in the shift position in the vehicle. Here, driving status classifier 35 outputs the position information to customizing controller 31. When the shift position indicated by the position information enters a position other than the park position, that is, when the vehicle shifts out of park, customizing controller 31 automatically switches a display layout to correspond to the state of travel of the vehicle so as to prevent the user from performing the customizing operation.

Here, since it is likely that the user is in the middle of customizing the display layout on the customization image, when the vehicle shifts out of park, customizing controller 31 stores, in layout storage 34, the display layout being customized. In other words, control device 10 detects a change in the shift position in the vehicle, and stores, when the vehicle shifts out of park, the display layout being customized as the layout information in layout storage 34.

### <Processing Operation>

A processing operation in vehicle display system 1a, a display method, and a recording medium according to the present embodiment will then be described.

### Operation Example 1

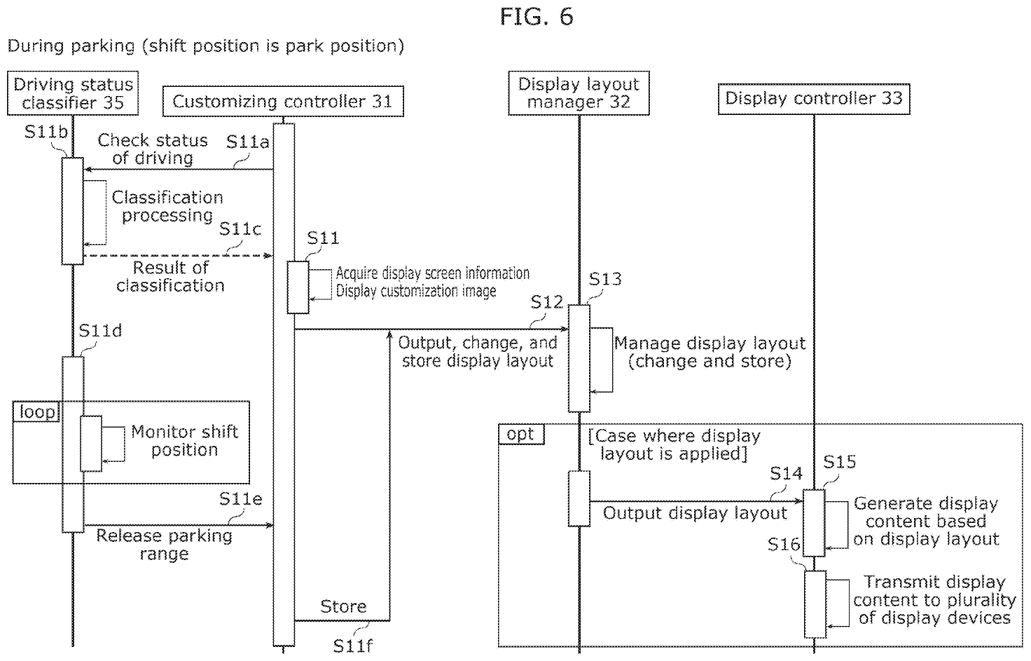

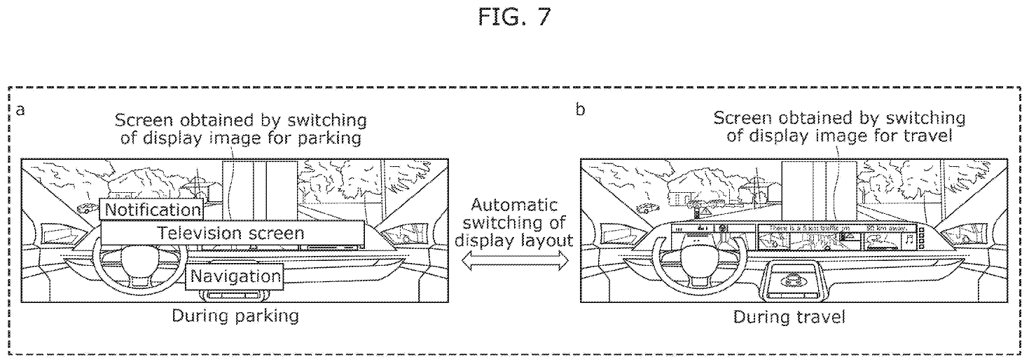

In the present operation example, a case (during parking) where the shift position is located in the park position will be described with reference to FIG. 6. FIG. 6 is a sequence diagram illustrating a processing operation when the shift position is located in the park position. FIG. 7 is a diagram illustrating how a display layout for parking (a in FIG. 7) and a display layout for travel (b in FIG. 7) are switched. The same operations as in FIG. 2 are identified with the same reference signs, and descriptions thereof will be omitted as necessary.

As shown in FIG. 6, customizing controller 31 of display customizer 30 first checks the status of driving with driving status classifier 35 (S11a).

Driving status classifier 35 acquires the degree of risk in the vehicle and the position information indicating the shift position from degree-of-risk calculator 22. Here, since the shift position is in the park position, driving status classifier 35 executes classification processing (S11b) to determine that the degree of risk is zero.

Driving status classifier 35 outputs the result (the result of the classification) of the determination that the degree of risk is zero to customizing controller 31 (S11c).

Then, in vehicle display system 1a, the processing operation in steps S11 to S16 is executed.

After driving status classifier 35 outputs the result of the classification to display customizer 30 (S11c), driving status classifier 35 monitors the shift position (S11d). In other words, driving status classifier 35 repeatedly determines whether the position information obtained by detecting a change in the shift position in the vehicle is acquired from shift position detector 21.

When driving status classifier 35 determines that the position information obtained by detecting a change in the shift position is acquired, that is, when the shift position is changed to a position other than the park position, driving status classifier 35 outputs, to customizing controller 31, information indicating that the vehicle shifts out of park, that is, the position information indicating that the shift position is in a position other than the park position (S11e).

Here, customizing controller 31 of display customizer 30 transmits the customization image via transmitter 41, connection manager 43, and the network to each of display devices 50, and thereby causes all display devices 50 to display the customization image (S11). In other words, the user is in the middle of performing customization on the customization image.

Even while the display layout is being customized, in order to store the display layout being customized, customizing controller 31 outputs it to display layout manager 32 (S11f). Then, the processing operation reaches step S13, and in vehicle display system 1a, the processing operation described above is executed.

The shift position is changed from the park position to a position other than the park position, and thus as shown in FIG. 7, the display of display devices 50 is switched from a in FIG. 7 to b in FIG. 7. This is because while the vehicle is being parked, functional safety is unlikely to be impaired, and thus information which is not essential is displayed on display devices 50. On the other hand, while the vehicle is traveling, information which is essential is displayed on display devices 50 such that the functional safety is not impaired. In other words, in display devices 50, the park position is changed to a position other than the park position, and thus the information which is not essential is switched to the information which is essential.

### Operation Example 2

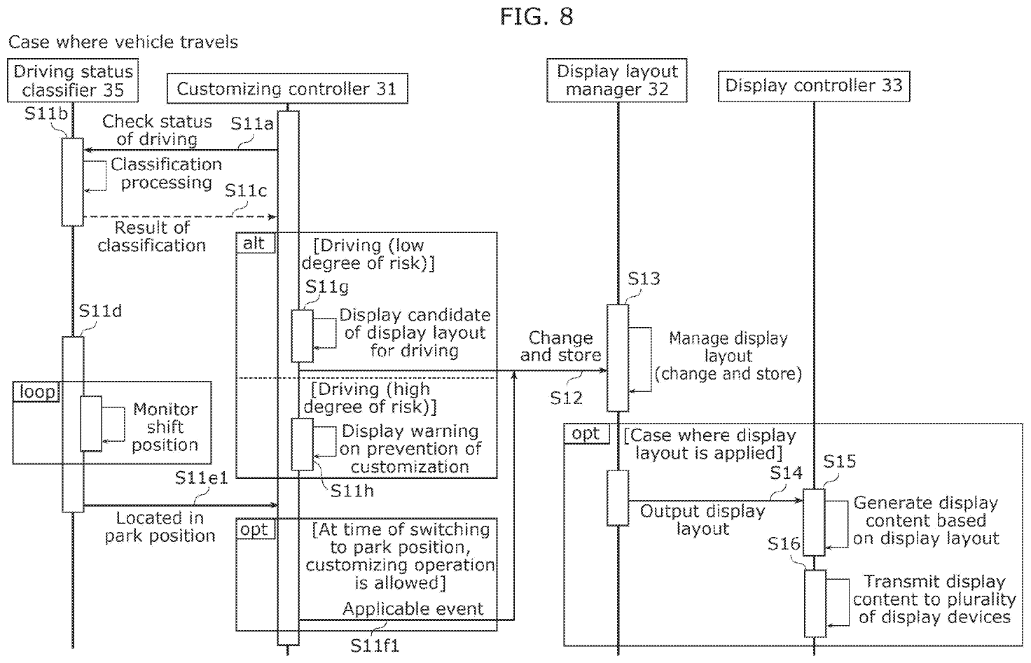

In the present operation example, a case (during travel) where the shift position is located in a position other than the park position will be described with reference to FIG. 8. FIG. 8 is a sequence diagram illustrating a processing operation when the shift position is located in a position other than the park position. The same operations as in FIG. 2 are identified with the same reference signs, and descriptions thereof will be omitted as necessary.

As shown in FIG. 8, customizing controller 31 of display customizer 30 first checks the status of driving with driving status classifier 35 (S11a).

When driving status classifier 35 acquires the degree of risk in the vehicle and the position information indicating the shift position from degree-of-risk calculator 22, driving status classifier 35 executes classification processing on the status of driving in the vehicle based on the degree of risk and the shift position indicated by the position information (S11b). For example, driving status classifier 35 uses the table indicating the relationship between the states of (1) to (3) and the cases of (4) to (6) in FIG. 5 to classify the degree of risk in the vehicle. In FIG. 5, for the combinations of (4) and (1) and (4) and (2) and the combination of (5) and (1), the degree of risk of the vehicle is assumed to be low, and for the other combinations, the degree of risk of the vehicle is assumed to be high. In the example of FIG. 5, the threshold value is set to 2.

After driving status classifier 35 executes the classification processing on the status of driving in the vehicle, driving status classifier 35 outputs the result of execution of the classification processing (the result of the classification) to customizing controller 31 (S11c).

When the degree of risk in the result of the classification is low (when the degree of risk is less than or equal to the threshold value), customizing controller 31 allows only a switch to the stored display layout for driving. This is because even in a case where a travel speed is low such as a case where the vehicle is driven slowly, since a risk is still present, customizing controller 31 prevents the arrangements, positions, and the like of part images from being changed by the customizing operation, and allows only a switch to the display layout (a candidate of the display layout) indicated by the layout information already stored in layout storage 34. Customizing controller 31 causes display device 50 to display the candidate of the display layout for driving (S11g).

When the degree of risk in the result of the classification is high (when the degree of risk is greater than the threshold value), customizing controller 31 prohibits the customizing operation to be performed with respect to the display layout and displays a warning (S11h). This is because in a case where the travel speed is high, since the vehicle is in a dangerous state, customizing controller 31 not only prevents the arrangements, positions, and the like of part images from being changed by the customizing operation but also prevents a switch to the display layout.

Then, in vehicle display system 1a, the processing operation in steps S12 to S16 is executed.

After driving status classifier 35 outputs the result of the classification to display customizer 30 (S11c), driving status classifier 35 monitors the shift position (S11d). In other words, driving status classifier 35 repeatedly determines whether the position information obtained by detecting a change in the shift position in the vehicle is acquired from shift position detector 21.

When driving status classifier 35 determines that the position information is acquired, that is, when the shift position is changed to the park position, driving status classifier 35 outputs, to customizing controller 31, the position information indicating that the shift position is located in the park position as information indicating that the shift position is changed to the park position (S11e1).

Here, even when the customizing operation capable of producing the display layout is prohibited, customizing controller 31 allows the user to perform the customizing operation capable of producing the display layout. Specifically, customizing controller 31 releases the restriction of the customizing operation, and outputs, in order to allow the customizing operation to be performed, the position information (that is, an applicable event for allowing the customizing operation) indicating that the shift position is located in the park position to display layout manager 32 (S11f1). Then, the processing operation reaches step S12, and in vehicle display system 1a, the processing operation described above is executed.

The shift position is changed from a position other than the park position to the park position, and thus as shown in FIG. 7, the information displayed on display devices 50 is switched from b in FIG. 7 to a in FIG. 7. This is because while the vehicle is traveling, the information which is essential is displayed on display devices 50 such that the functional safety is not impaired. On the other hand, while the vehicle is being parked, the functional safety is unlikely to be impaired, and thus the information which is not essential is displayed on display devices 50. In other words, the shift position is changed from a position other than the park position to the park position, and thus the information displayed on display devices 50 is switched from the information of b in FIG. 7 which is essential to the information of a in FIG. 7 which is not essential.

### <Functional Effects>

The functional effects of vehicle display system 1a according to the present embodiment will then be described.

As described above, in vehicle display system 1a according to the present embodiment, control device 10 detects a change in the shift position in the vehicle and automatically switches the display layout to correspond to the state of travel of the vehicle when the vehicle shifts out of park.

In this way, since the vehicle shifts out of park, and this means that the vehicle starts to travel, for example, control device 10 can switch, according to the state of travel of the vehicle, the display layout used immediately before the start of travel to another display layout such that the customizing operation with respect to the display layout performed by the user is minimized. Hence, the information which is essential for the user can be displayed, and thus it is possible to ensure safety on the travel of the vehicle.

In vehicle display system 1a according to the present embodiment, control device 10 includes layout storage 34 that stores the layout information indicating the display layout. Control device 10 detects a change in the shift position in the vehicle, and stores, as the layout information, in layout storage 34, the display layout subjected to the customizing operation when the vehicle shifts out of park.

In this way, even when the shift position is changed to a position other than the park position while the customizing operation is being performed, the display layout being operated can be automatically stored. Hence, it is easy to handle vehicle display system 1a.

In vehicle display system 1a according to the present embodiment, control device 10 restricts the customizing operation to be performed with respect to the display layout based on the shift position in the vehicle and the degree of risk during travel.

In this way, when the degree of risk is high, in order to restrict the customizing operation to be performed with respect to the display layout, control device 10 can prevent the customizing operation from being received from the user. When the degree of risk is low, in order to restrict the customizing operation to be performed with respect to the display layout, control device 10 can receive such a limited customizing operation (for example, only the switching of the display layout) from the user as not to prevent the driving of the vehicle.

Since when the vehicle starts to travel, the customizing operation to be performed with respect to the display layout is restricted, the customizing operation by the user can be stopped when the vehicle starts to travel. Consequently, while the vehicle is traveling, the user can be prevented from performing the customizing operation.

In vehicle display system 1a according to the present embodiment, control device 10 allows the customizing operation to be performed in detail when the shift position in the vehicle is located in the park position.

In this way, since the shift position is located in the park position, and this means that the vehicle stops travel (for example, during parking), even when the user performs the customizing operation after the stop of the vehicle, it is possible to ensure the safety. Hence, it is possible to receive the customizing operation performed by the user without restriction.

In vehicle display system 1a according to the present embodiment, control device 10 calculates the degree of risk on the travel of the vehicle when the shift position in the vehicle is in a position other than the park position, allows, when the degree of risk calculated is less than or equal to the threshold value, only a switch to the stored display layout for driving, and prohibits, when the degree of risk calculated is greater than the threshold value, the customizing operation to be performed with respect to the display layout.

In this way, when the degree of risk is low, in order to restrict the customizing operation to be performed with respect to the display layout, control device 10 can receive a limited customizing operation from the user as long as the travel of the vehicle is not dangerous.

### (Other Variations)

Although the vehicle display system, the display method, and the recording medium according to the present disclosure have been described above based on the embodiments described above, the present disclosure is not limited to these embodiments. Various variations of the embodiments conceived by a person skilled in the art without departing from the spirit of the present disclosure may be included in the scope of the present disclosure.

For example, portions included in the vehicle display system, the display method, and the recording medium according to the embodiments described above are typically realized as an LSI circuit which is an integrated circuit. Each of them may be integrated into one chip or they may be integrated into one chip so as to include part or all of them.

The integration is not limited to LSI, and may be realized by a dedicated circuit or a general-purpose processor. A field programmable gate array (FPGA) which can be programmed after the manufacturing of an LSI circuit or a reconfigurable processor in which the connection and setting of circuit cells inside an LSI circuit can be reconfigured may be utilized.

Constituent elements in the embodiments described above may be formed with dedicated hardware or may be realized by executing software programs suitable for the constituent elements. A program executer such as a CPU or a processor may read and execute software programs recorded in a recording medium such as a hard disk or a semiconductor memory to realize the constituent elements.

All the numbers used in the above description are used as examples for specifically describing the present disclosure, and the embodiment of the present disclosure is not limited to the numbers which are used as examples.

The division of functional blocks in the block diagram is an example, and a plurality of functional blocks may be realized as one functional block, one functional block may be divided into a plurality of blocks, or part of functions may be transferred to another functional block. The functions of a plurality of functional blocks which have similar functions may be processed by a single hardware or software unit in parallel or in a time division manner.

The order in which the steps in the flowchart are performed is used as an example for specifically describing the present disclosure, and an order other than the order described above may be adopted. Part pf the steps may be performed at the same time (in parallel) with another step.

Embodiments obtained by performing, on the embodiments described above, various variations conceived by a person skilled in the art and embodiments realized by arbitrarily combining the constituent elements and functions in the embodiments described above without departing from the spirit of the present disclosure are also included in the present disclosure.

While various embodiments have been described herein above, it is to be appreciated that various changes in form and detail may be made without departing from the spirit and scope of the present disclosure as presently or hereafter claimed.

### Further Information about Technical Background to this Application

The disclosure of the following patent application including specification, drawings, and claims are incorporated herein by reference in their entirety: Japanese Patent Application No. 2021-060131 filed on Mar. 31, 2021.

### INDUSTRIAL APPLICABILITY

The present disclosure can be utilized, for example, for vehicles and other devices and systems other than vehicles which install a plurality of display devices.

1. A vehicle display system comprising:
a control device that causes at least one of a plurality of display devices to display a customization image on which a display screen can be customized and that transmits, to each of the plurality of display devices, display content generated based on a display layout customized by a user on the customization image,
wherein each of the plurality of display devices displays the display content received from the control device.

2. The vehicle display system according to claim 1,
wherein the control device:
manages an application for customizing the customization image, and
displays the customization image on each of the plurality of display devices in accordance with a customization restriction corresponding to a status of driving of a vehicle installing the vehicle display system.

3. The vehicle display system according to claim 1,
wherein the control device:
acquires display screen information that is information on the plurality of display devices; and
causes, when a customizing operation is performed with respect to the display layout, the plurality of display devices to respectively display, based on the display screen information, texture images imitating the plurality of display devices.

4. The vehicle display system according to claim 1,
wherein the control device:
detects a change in a shift position in a vehicle; and
automatically switches the display layout to correspond to a state of travel of the vehicle when the vehicle shifts out of park.

5. The vehicle display system according to claim 1,
wherein the control device:
includes a layout storage that stores layout information indicating the display layout;
detects a change in a shift position in a vehicle; and
stores, as the layout information, in the layout storage, the display layout subjected to a customizing operation when the vehicle shifts out of park.

6. The vehicle display system according to claim 1,
wherein the control device restricts a customizing operation to be performed with respect to the display layout based on a shift position in a vehicle and a degree of risk during travel.

7. The vehicle display system according to claim 6,
wherein the control device allows the customizing operation to be performed in detail when the shift position in the vehicle is located in a park position.

8. The vehicle display system according to claim 7,
wherein the control device:
calculates the degree of risk on the travel of the vehicle when the shift position in the vehicle is in a position other than the park position;
allows, when the degree of risk calculated is less than or equal to a threshold value, only a switch to a stored display layout for driving; and
prohibits, when the degree of risk calculated is greater than the threshold value, the customizing operation to be performed with respect to the display layout.

9. The vehicle display system according to claim 1, further comprising:
a plurality of display devices that display the customization image which can be customized on a display screen.

10. A display method comprising:
displaying a customization image on a display screen;
transmitting, to each of a plurality of display devices, display content generated based on a display layout customized by a user on the customization image; and
displaying, by each of the plurality of display devices, the display content received from a control device.

11. A non-transitory computer-readable recording medium for use in a computer, the recording medium having a computer program recorded thereon for causing the computer to execute the display method according to claim 10.
